(19) United States
(12) Patent Application Publication
(10) Pub. No.: US 2010/0092643 A1
(43) Pub. Date: Apr. 15, 2010

(54) PROCESS FOR PRODUCING MULTI-GRAIN CHIP PRODUCTS USING DRY INGREDIENTS

(75) Inventors: Gerry M. Hertzel, Sabetha, KS (US); Brian S. Plattner, Sabetha, KS (US)

Correspondence Address: HOVEY WILLIAMS LLP, 10801 Mastin Blvd., Suite 1000, Overland Park, KS, 66210, US

(73) Assignee: Wenger Manufacturing, Inc., Sabetha, KS (US)

(21) Appl. No.: 12/252,235

(22) Filed: Oct. 15, 2008

(51) Int. Cl. A21D 8/02; A21D 13/00

(52) U.S. Cl. 426/560

(57) ABSTRACT

Improved processes are provided for the production of grain-based products and especially multi-grain chips. The preferred process makes use of a single mixture of dry ingredients containing respective starch fractions having different levels of gelatinization. The starting mixture is preconditioned and extruded so as to form the mixture but without any substantial additional gelatinization of the starches. Moisture is added to the mixture during both preconditioning and extruding such that the extrudate exhibits both different levels of gelatinization in the starches therein, and also has portions with different levels of moisturization.

### BACKGROUND OF THE INVENTION

1. Field of the Invention

The present invention is broadly concerned with processes for production of edible grain-containing products. More particularly, the invention is concerned with such processes which can be used to produce multi-grain chips and similar items, using a single starting mixture of dry ingredients, thereby avoiding the need for costly and equipment-intensive procedures typically used in chip production.

2. Description of the Prior Art

Corn or masa-based snack products have long been produced and sold throughout the world. Among these products are multi-grain chips which have achieved considerable commercial success owing to their texture and palatability, and the perceived health benefits thereof. Many products of these types require batch-cooking of whole corn by boiling the corn for 10-20 minutes in an alkaline (e.g., lime) environment. After cooking, the corn is ground, sieved, and, in the case of multi-grain chips, mixed with the balance of the recipe (wheat, rice, wheat bran among other things). Thereupon, the recipe is extruded to form the chip product, followed by hot oil frying. These conventional processing steps are both time consuming and expensive. For example, the batch frying requires considerable equipment and normally represents the rate-limiting step in the overall process. The following references describe conventional snack processes: U.S. Pat. Nos. 4,126,706; 4,973,481; 4,623,550; 5,362,511; 4,770,891; 4,567,051; and 4,680,191.

Given these drawbacks in present-day processes, it would be highly advantageous to develop processes making use of a single base mixture of preferably dry ingredients (i.e., containing only native water of the ingredients) which could be extrusion-processed without any pretreatment such as boiling or the like. U.S. Pat. No. 3,780,186 describes a process for producing corn paste food stuffs including substantially equal amounts of regular ungelatinized corn flour and pregelatinized corn flour, with a minor amount of oil or fat. Such a mixture is then extruded in a pasta extruder to yield a final product which is dried, making it suitable for cooking. However, the process makes use of gelatinized corn flour obtained by tempering in cold water for 1-2 hours, followed by crushing and pressing through heated steel rollers. U.S. Pat. No. 4,325,976 is directed to a reformed rice product made by extruding a rice dough through a pasta extruder. The dough includes pregelatinized and ungelatinized rice flour together with salt and fat. Water is added to these ingredients with mixing, followed by extrusion.

### SUMMARY OF THE INVENTION

The present invention overcomes the problems outlined above and provides significantly improved processes for the production of edible grain-containing products, and especially multi-grain chips. Broadly speaking, the processes of the invention include first providing a starting mixture including grain and having therein respective start factions with different levels of gelatinization. Preferably, the mixture includes fully gelatinized starch, as well as partially gelatinized starch and wholly ungelatinized grain-bearing starch. The fully gelatinized and partially gelatinized fractions can be in the form of free starch or as a part of grain(s).

The starting mixture is then passed in serial order through a preconditioner and an extruder without any substantial additional gelatinization of the starch within the mixture. The preconditioner and extruder are conventional, but it is preferred to use a twin screw extruder. During the course of processing, moisture is added to the mixture both in the preconditioner and in the extruder to achieve a total added moisture content. From about 30-65% of this total added moisture content is added during passage of the mixture through the preconditioner, with the balance of this total moisture added content being provided during extrusion.

Importantly, the extrudate from the extruder has portions thereof exhibiting different levels of gelatinization, and also portions having different levels of moisturization. Thus, the differently gelatinized starch fractions in the starting mixture are essentially maintained, although they may be somewhat elevated. This results from the gentle processing in both the preconditioner and extruder.

It has been found that by a judicious selection of starting ingredients and processing conditions, fully acceptable grain-based products can be produced which are the full equivalent of prior art products made by grain boiling and subsequent extrusion.

### DETAILED DESCRIPTION OF THE PREFERRED EMBODIMENTS

During the course of development of the present invention, a number of attempts were made to prepare multi-grain chip products by combining all of the ingredients into a single base mixture, followed by preconditioning and extrusion of the mixture. The results of these preliminary tests were inconsistent. In some cases a reasonably acceptable product resulted, but in others the texture and appearance of the chips were unacceptable.

Upon further analysis of the problem, it was discovered that commercially acceptable chip products could be produced from a single base mixture by a careful selection of ingredients and processing conditions. One very important factor was that the base mixture needed to have respective fractions thereof of differing gelatinization levels. That is, it was found that an acceptable base mixture should have a starch fraction which was essentially completely gelatinized, a fraction which contained partially gelatinized starch, and starch-bearing grains which were not gelatinized. The fully gelatinized starch is preferably though not necessarily in the form of free starch, and is present at a level of up to about 25% by weight of the total composition, more preferably up to about 15% by weight, and most preferably from about 3-10% by weight. In addition, it was determined that the mixture during processing should result in different levels of moisturization in respective portions of the mixture. Differential moisturization generally means that some of the starch and/or grain in the starting mixture would be fully moisturized throughout the structures thereof during processing, whereas other starch and/or grain would be only partially moisturized, in that the interior of the starch and/or grain particles would remain partially or essentially completely dry in the final extrudate. This was an extremely important discovery, which is at variance with conventional wisdom in the extrusion art where an effort is made to ensure uniform processing of starting ingredients so that all fractions thereof are equally cooked (i.e., gelatinized) and moisturized.

In order to provide an indication of the proper ingredients to be used in a given base mixture, resort can be had to mixture analysis using a Rapid Visco Analyzer (RVA), such as that obtained from Newport Scientific. In RVA testing, a dry test mixture is provided and is mixed with water to give a ratio of 3.5 grams of solids to 25 grams of water. The resultant slurry is slowly stirred as the temperature profile of the RVA is varied through a hold, heat, hold, cool, and hold temperature cycle. This RVA analysis yields a “fingerprint” of the starch-based mixture and an indication of the cook characteristics of the mixture. The final or “set back” viscosity of the mixture is related to the overall level of thermal processing experienced by the mixture. High final viscosity values are related to low levels of heat treatment, whereas low final viscosity values indicate higher levels of heat treatment. RVA analyses of these types are discussed in Extruded Products and Degree of Cook, The RVA Handbook, pp. 77, 80, and 82-83, by Paul J. Whalen and published by AACC International (2007), incorporated by reference herein.

Using the RVA, it is therefore possible to analyze a known product such as batch-cooked whole corn, and to compare the RVA results with a proposed test mixture in an effort to duplicate the known product. Research leading to the present invention revealed that the RVA final viscosity results from a test mixture should be within about ±10% (more preferably ±7%) ofthe final viscosity results of the known product. Viscosities in excess ofthese limits generally produce unacceptable characteristics in the final products.

The preferred apparatus for carrying out the invention includes a preconditioner with a downstream extruder. The preconditioner is preferably a Wenger DDC preconditioner of the type described in U.S. Pat. No 4,752,139. Such preconditioners include a pair of mixing shafts within juxtaposed, differently sized chambers of an elongated housing, with the shafts having outwardly extending paddles thereon. A mixture entering the preconditioner is mixed and agitated by the rotating shafts while moisture in the form of water and/or steam is injected into the mixture. The preferred extruder is a Wenger TX twin screw extruder having an elongated, multiple-head extruder barrel with a pair of elongated, axially rotatable screws within the barrel. The outlet of the preconditioner is directly coupled with the inlet of the extruder barrel. The outlet of the extruder barrel is provided with a restricted orifice die in order to shape the final extrudate. The extrudate is then severed as required to produce a product ready for subsequent cooking. This may involve either baking or flying, depending upon the desired characteristics for the final product.

This equipment is carefully controlled in the processes of the invention in order to achieve commercially acceptable products. Thus, in the preconditioner only a portion of the total added water for the base mixture is injected. Generally, the amount of moisture (usually in the form of water) injected into the preconditioner is from about 30-65% ofthe total added moisture content for the mixture, and more preferably about 45-55% thereof. Processing time in the preconditioner is typically from about 1-6 minutes (more preferably from about 2-4 minutes) and without any significant cooling or temperature elevation of the mixture. Preferably, the temperature of the mixture exiting the preconditioner should be within about 5° C. of ambient temperature.

The extrusion processing of the preconditioned mixture is carried out under similarly controlled conditions, in order to avoid any substantial additional gelatinization of the starch within the mixture. To this end, the residence time of the mixture in the extruder is usually in the range of from about 10-60 seconds, more preferably from about 15-30 seconds. The temperature conditions within the extruder are controlled, normally by passing a cooling fluid through the external jackets of the extruder heads, in order that the maximum temperature experienced by the mixture in the extruder barrel is up to about 70° C. Further, the temperature of the extrudate leaving the die should be from about 40-75 ° C., more preferably from about 60-70° C. The maximum pressure condition in the extruder are between about 500-1200 psi, more preferably from about 650-1000 psi.

By carefully controlling the amount of moisture added to the mixture in the preconditioner and extruder, while carrying out the process so as to avoid any substantial additional gelatinization of the starch within the mixture, the aims of the invention can be met. Those skilled in the art will appreciate that the processing conditions can be varied while still achieving good results. Thus, a smaller amount of moisture may be added in the preconditioner coupled with longer processing times; alternately, a greater amount of moisture may be used with lesser processing time. Temperature control is similarly variable, e.g., very short extruder residence times can be used with somewhat higher temperature conditions. The goal is to minimize any additional gelatinization of the starch within the mixture throughout the entire process, while creating differential moistening of respective starch and/or grain fractions. Preferably, the starch fractions within the mixture subject to gelatinization (i.e., the partially gelatinized or wholly ungelatinized starches) should experience additional gelatinization levels of no more than about 15%, more preferably no more than about 5%, compared with these gelatinization levels at the beginning of the process.

Although the invention is not limited to the production of multi-grain chips or similar products, when such is desired the starting mixture advantageously includes respective quantities of partially gelatinized starch, essentially completely gelatinized starch, and a pluralality of ungelatinized grains. Such grains are usually selected from the group consisting of rice, oat, wheat barley, sorghum, corn, milo, and mixtures thereof. Particularly good results have been found using a mixture comprising from about 20-55% by weight partially gelatinized corn, from about 1-10% by weight ofpregelatinized starch, from about 15-35% by weight ungelatinized rice flour, from about 5-25% by weight ungelatinized whole oat flour, and from about 1-10% by weight ungelatinized wheat flour. Additional ingredients may include minor amounts of wheat bran and sugar.

The following examples set forth the preferred apparatus and methods in accordance with the invention. It is to be understood, however, that these examples are provided by way of illustration and nothing therein should be taken as a limitation upon the overall scope of the invention.

### EXAMPLE 1

In this example, two separate processing runs were carried out to produce a multi-grain chip product using a three-head Wenger Model TX 57 twin screw extruder with an upstream Model 2 DDC preconditioner. The extruder was equipped with a die spacer and a conventional chip die operable to produce a wavy chip-type extrudate.

The starting mixture was made up of 42% by weight partially pregelatinized whole corn flour, and 4% by weight pregelatinized corn starch. In addition, the mixture included 24% by weight ungelatinized brown rice flour, 15% by weight ungelatinized whole oat flour, and 6% by weight ungelatinized whole wheat flour, 4% by weight coarse clean hard red winter wheat bran, and 5% by weight sugar.

In the process, the initially dry mixture (except for native water) was fed into the preconditioner and partially moisturized therein. The preconditioned mixture was then directed into the twin screw extruder in order to form the product into a wavy sheet-like extrudate which was cut. During this processing, care was taken not to fully moisturize all of the mixture, and also to prevent any substantial additional cooking of the mixture. The extruder barrel was cooled by passing cold water through the external jackets of the extruder barrel heads.

The following Table 1 sets forth the processing condition for these two runs:

TABLE 1

RUN NUMBER

| | |
|---|---|
| 1 | 2 |

DRY RECIPE INFORMATION

| | | |
|---|---|---|
| Density (kg/m³) | 597 | 597 |
| Feed Rate (kg/hr) | 74 | 74 |
| Feed Screw Speed (RPM) | 12 | 13 |

PRECONDITIONING INFORMATION

| | | |
|---|---|---|
| Preconditioner Speed (RPM) | 400 | 400 |
| Steam Flow to Preconditioner (kg/hr) | None | None |
| Water Flow to Preconditioner (kg/hr) | 17.33 | 17.14 |
| Preconditioner Discharge Temp (° C.) | 28 | 28 |
| Moisture Entering Extruder (% wb) | 27.54 | 26.62 |

EXTRUSION INFORMATION

| | | |
|---|---|---|
| Extruder Shaft Speed (RPM) | 235 | 235 |
| Extruder Motor Load (%) | 30 | 30 |
| Water Flow to Extruder (kg/hr) | 18.73 | 18.77 |
| Temperature First Head (° C.) | 28 | 27 |
| Temperature Second Head (° C.) | 35 | |
| Temperature Third Head (° C.) | 47 | 47 |
| Die Spacer Pressure (kPa) | 4749.8 | 4915.6 |

FINAL PRODUCT INFORMATION

| | | |
|---|---|---|
| Extruder Discharge Moisture (% wb) | 35.22 | 35.89 |
| Extruder Discharge Temperature (° C.) | 74 | 74 |

The extrudate emerging from the extruder was passed on to a continuous belt running at a speed of 127 ft/mn. The product was cut into chip sizes and was then fried in 375° F. oil for 40 seconds to obtain a final product. The resultant multi-grain chip product was very acceptable.

### EXAMPLE 2

In this example, an optimized run was carried out to produce a multi-grain chip product using the same equipment as in Example 1.

The starting mixture was made up of 41% by weight partially pregelatinized whole corn flour, and 5% by weight pregelatinized corn starch. In addition, the mixture included 24% by weight ungelatinized brown rice flour, 15% by weight ungelatinized whole oat flour, and 6% by weight ungelatinized whole wheat flour, 4% by weight coarse clean hard red winter wheat bran, and 5% by weight sugar.

As in Example 1, the initially dry mixture (except for native water) was fed into the preconditioner and partially moisturized therein. The preconditioned mixture was then directed into the twin screw extruder in order to form the product into a wavy sheet-like extrudate which was cut. During this processing, care was taken not to fully moisturize all of the mixture, and also to prevent any substantial cooking of the mixture.

The following Table 2 sets forth the processing condition for these two runs:

TABLE 2

RUN NUMBER
3

DRY RECIPE INFORMATION

| | |
|---|---|
| Feed Rate (kg/hr) | 110 |
| Feed Screw Speed (RPM) | 16 |

PRECONDITIONING INFORMATION

| | |
|---|---|
| Preconditioner Speed (RPM) | 300 |
| Steam Flow to Preconditioner (kg/hr) | None |
| Water Flow to Preconditioner (kg/hr) | 11.1 |
| Preconditioner Discharge Temp (° C.) | 22 |
| Moisture Entering Extruder (% wb) | 20.58 |

EXTRUSION INFORMATION

| | |
|---|---|
| Extruder Shaft Speed (RPM) | 225 |
| Extruder Motor Load (%) | 32 |
| Water Flow to Extruder (kg/hr) | 16.26 |
| ¹Control/Temperature First Head (° C.) | 20/23 |
| Control/Temperature Second Head (° C.) | 20/24 |
| Control/Temperature Third Head (° C.) | 40/48 |
| Head 2/Pressure (kPa) | 2758 |
| Head 3/Pressure (kPa) | 8274 |

FINAL PRODUCT INFORMATION

| | |
|---|---|
| Extruder Discharge Moisture (% wb) | 31.67 |

¹Barrel temperature control was established by directing water through the external jackets of the barrel heads where 20° C. represents the water temperature and 23° C. is the actual head temperature.

The extrudate emerging from the extruder was passed on to a continuous belt running at a speed of 127 ft/mn. The product was cut into chip sizes and was then fried in 375° F. oil for 40 seconds to obtain a final product. The resulted multi-grain chip product was very acceptable and commensurate with present-day commercially sold multi-grain chips

We claim:

1. A process for producing an edible grain-containing product, comprising the steps of:
providing a starting mixture including grain and having therein respective starch fractions having different levels of gelatinization;
passing said mixture in serial order through a preconditioner and an extruder without any substantial additional gelatinization of the starch within the mixture, said extruder including an elongated barrel having an inlet and a restricted orifice die outlet, and an axially rotatable screw within said barrel; and
adding moisture to said mixture during passage thereof through both said preconditioner and said extruder to achieve a total added moisture content, with from about 30-65% of said total added moisture content being added during passage of the mixture through said preconditioner, and the remainder of said total added moisture content being added during passage of the mixture through said extruder,
the extrudate having portions thereof exhibiting different levels of gelatinization, and portions having different levels of moisturization.

2. The process of claim 1, including the step of adding about 35-50% of said total added moisture content to said mixture during passage thereof through said preconditioner.

3. The process of claim 1, including the step of agitating of said mixture within said preconditioner during said moisture addition.

4. The process of claim 1, the residence time of said mixture in said preconditioner being from about 1-6 minutes.

5. The process of claim 1, the temperature of said mixture from said extrudate being from about 40-75° C.

6. The process of claim 1 the maximum temperature of said mixture during passage thereof through said extruder being up to about 70° C.

7. The process of claim 1, said mixture including a plurality of different grains.

8. The process of claim 1, the residence time of said mixture in said extruder being from about 10-60 seconds.

9. The process of claim 1, wherein the mixture exiting said preconditioner has a temperature within about 5° C. of ambient temperature.

10. The process of claim 1, said mixture comprising respective quantities of partially gelatinized starch, essentially completely gelatinized starch, and a plurality of ungelatinized grains.

11. The process of claim 10, said ungelatinzied grains selected from the group consisting of rice, oat, wheat, barley, sorghum, corn, milo, and mixtures thereof.

12. The process of claim 11, said mixture comprising from about 20-55% by weight partially gelatinized corn, from about 1-10% by weight of pregelatinized starch, from about 15-35% by weight ungelatinized rice flour, from about 5-25% by weight ungelatinized whole oat flour, and from about 1-10% by weight ungelatinized wheat flour.

13. The process of claim 1, including the step of subsequently cooking said extrudate from said extruder.

14. The process of claim 13, said subsequent cooking step comprising the step of baking or frying said extrudate.

15. A product produced by the process of claim 1.
